(19) United States
(12) Patent Application Publication
(10) Pub. No.: US 2017/0161527 A1
(43) Pub. Date: Jun. 8, 2017

(54) SYSTEMS AND METHODS OF PROTECTING INTELLECTUAL PROPERTY

(71) Applicant: LOCKHEED MARTIN CORPORATION, Bethesda, MD (US)

(72) Inventors: Eugene J. Urda, Binghamton, NY (US); Charles H. Dando, III, Vestal, NY (US)

(21) Appl. No.: 14/959,677

(22) Filed: Dec. 4, 2015

(51) Int. Cl. G06F 21/86; G06F 21/88

(52) U.S. Cl. CPC G06F 21/86; G06F 21/88

(57) ABSTRACT

The present disclosure relates to systems and methods of protecting intellectual property and, more particularly to systems and methods of disabling electronic or software components. The system includes: a measurement component provided with an enclosure, which measures environmental conditions within the enclosure; and a countermeasure component provided with the enclosure, which renders inoperative at least one electronic or software component within the enclosure when the measurement component detects that the conditions within the enclosure have changed beyond a predetermined amount.

### FIELD OF THE INVENTION

The present invention relates to systems and methods of protecting intellectual property and, more particularly to systems and methods of disabling and/or destroying hardware and/or software components within an enclosed assembly.

### BACKGROUND DESCRIPTION

Anti-tamper devices provide an important layer of protection or barrier against unlawful or nefarious activities. In one type of application, by way of example, an anti-tamper device is designed to protect electronic or software components from being reverse engineered or stolen by unauthorized persons or governments. These electronic or software components may be related to commercial as well as military or other government applications.

By fully integrating an anti-tamper device with the designed component or system, it is possible to ensure that the anti-tamper device will work in its intended manner. For example, for software components, the designer can ensure that software code is compatible with the anti-tamper device, from a systems integration standpoint. In another example, using a hardware component, the designer can engineer the system to disable the hardware in an efficient and time sensitive manner. That is, a system designer or engineer, at the beginning of the design phase, can design the particular electronic device, for example, with an integrated anti-tamper device.

### SUMMARY OF THE INVENTION

In an aspect of the invention, a system comprises: a measurement component provided with an enclosure, which measures environmental conditions within the enclosure; and a countermeasure component provided with the enclosure, which renders inoperative at least one electronic or software component within the enclosure when the measurement component detects that the conditions within the enclosure have changed beyond a predetermined amount.

In an aspect of the invention, a system comprises: an enclosure comprising a board and a cover hermetically sealed to the board; a first component provided with the enclosure and mounted to the board; a second component provided with the enclosure and mounted to the board, the second component detects an environmental condition within the enclosure; and a third component provided with the enclosure and mounted to the board, the third component disables or destroys the first component upon the second component detecting that the environmental condition within the enclosure has changed.

In an aspect of the invention, a method comprises: monitoring an environmental condition with an enclosure; detecting that the environmental condition has changed; and disabling an electronic or software component, upon the detecting of the change of the environmental condition.

### BRIEF DESCRIPTION OF THE DRAWINGS

The invention is described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a modular system in accordance with aspects of the invention.

FIG. 2 is a flow chart showing steps in accordance with aspects of the invention.

### DETAILED DESCRIPTION OF EMBODIMENTS OF THE INVENTION

The present invention relates to systems and methods of protecting intellectual property and, more particularly to systems and methods of disabling and/or destroying hardware and/or software components within an enclosed assembly. In more specific embodiments, the systems and methods are designed, configured and/or structured to neutralize (e.g., destroy) electronic and/or software related components of an existing system so that they cannot be used, stolen or reverse engineered.

Advantageously, the systems and methods described herein offer a robust and unique electro-mechanical method of protecting commercial intellectual property, with aspects allowing it to be “invisible” to the reverse engineer (or other person) attempting to gain access to the intellectual property. This is unlike conventional commercial mechanical protection mechanisms which contain visible elements, whether obvious to the naked eye, or by X-ray, or by eventually deriving what the mechanism is by “sacrificing” a first piece product to defeat the mechanism on a second piece product (e.g., grinding away at adhesive or metal to reach a tamper detection electronic mesh which was not originally visible by X-ray).

In embodiments, the systems and methods can be used to protect a wide range of commercial applications from unlawful use, theft or reverse engineering including, e.g., electronics, components, circuit boards, circuit cards, proprietary software loads, encryption keys, etc. (hereinafter referred generally as “intellectual property”). The systems and methods can be used to protect such intellectual property against competitors, adversaries, reverse engineers, etc., trying to steal, use, or modify the intellectual property. The systems and methods described herein can be implemented in many industries including, but not limited to, medical, automotive, banking and credit, and military, among several others.

In embodiments, the system can comprise a modular component configured to disable, destroy and/or alter electronic and/or software components housed within an enclosure or associated with the enclosed assembly. More specifically, in embodiments, the system of the invention is configured to be installed into existing electronic packages (generally referred to as “boxes”). The system is designed to be implemented in a finalized system, making it extremely valuable for deployed systems with hardware and/or software components that can use anti-tampering systems to protect the intellectual property. This is especially useful in military applications, as well as other sensitive systems which require protection from nefarious activities.

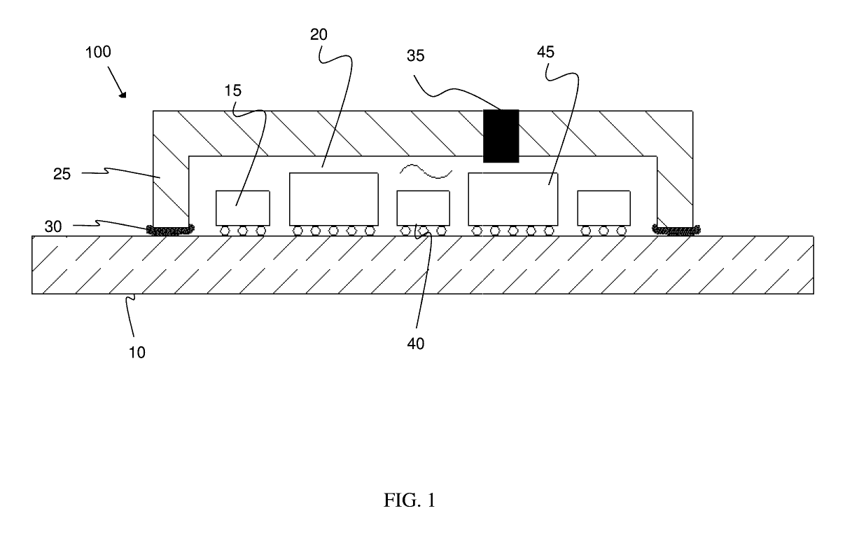

More specifically, FIG. 1 shows a modular system in accordance with aspects of the invention. In FIG. 1, the system is generally depicted as reference numeral 100. The system 100 is a modular system which may, for example, be a single hermetically sealed RF component or be a sealed FPGA containing proprietary software loads and encryption keys. For example, in embodiments, the system 100 may include, for example, circuitry or electronic components 15 that are mounted to a circuit card or board (generally noted as a “board”) 10 and provided within a hermetically enclosed space 20. In embodiments, the enclosed space 20 can be provided by a cover 25 hermetically sealed to the board 10, by seal 30. The circuitry or components 15 can be representative of any intellectual property such as, e.g., electronics, RF components, circuit boards, circuit cards, proprietary software loads, encryption keys, VME cards, etc.

The hermetically sealed enclosed space 20 can be filled with, e.g., a controlled amount of air pressure or lack thereof, or a controlled amount of a gas, such as CO2, or a controlled amount of a perfume, which is provided through a temporary injection hole or valve which is plugged or sealed as shown by reference numeral 35. In alternate embodiments, in lieu of injecting the substance into the enclosed space 20, any of the components, e.g., components 15, 40, 45, or an additional component, mounted within the enclosed space 20 can be designed to contain a controlled amount of the substance and discharge the substance upon the enclosed space being hermitically sealed or at the occurrence of another predetermined event, e.g., within a certain amount of time, or an external triggering event, etc. For example, the component could release the controlled amount of the substance by means of a software triggering feature. In embodiments, the air pressure, controlled amount of gas, or perfume are environmental conditions within the enclosure 20. The environmental condition can also be a vacuum.

Still referring to FIG. 1, a measurement and/or monitoring component 40 is provided on the board 10 and, more specifically, within the hermetically enclosed space 20. The measurement and/or monitoring component 40 can be, for example, a pressure gauge, moisture detector, odor detector, or other known measurement and/or monitoring device. In embodiments, the measurement and/or monitoring component 40 can measure and/or monitor the amount of controlled substance provided within the enclosed space 20, or alternative, can measure the vacuum within the enclosure 20.

For example, the measurement and/or monitoring component 40 can measure the controlled amount of air pressure, or gas, such as CO2, or detect an odor of the perfume and, importantly, detect losses of such substances after the product is fielded or as it sits in a factory or warehouse, as examples. In additional embodiments, the measurement and/or monitoring component 40 can detect a vacuum leak (or other environmental conditions within the enclosure), which would be indicative of a tampering event, e.g., the cover 25 and the enclosed space 20 being opened. Accordingly, the measurement and/or monitoring component 40 will detect that the environmental condition within the enclosure 20 has changed by a certain predetermined amount.

As should be understood by those of skill in the art, by detecting the loss of such substances (or lack of vacuum), etc., it is possible to detect a tampering of the package. For example, a loss in the amount of the substance would indicate that the product is being tampered with by someone trying to gain access to the intellectual property elements housed within the enclosure 20 (i.e., drilling a hole through the enclosure to obtain access to the enclosed components 15).

The system 100 further includes a component (e.g., countermeasure component) 45 which is designed, structured and/or operative to disable, destroy and/or alter the component 15. In embodiments, the measurement component 40 and the countermeasure component 45 can be a single component. The countermeasure component 45 can be, for example, circuitry designed to erase memory or erase or disable proprietary software algorithms and/or encryption keys, or disable or destroy those components and circuitry associated with the intellectual property if and when a loss in the amount of the controlled substance is detected by the measurement and/or monitoring component 40. For example, the countermeasure component 45 can be an electrostatic discharge device (ESD), electromagnetic pulse device (EMP), a chemical device, an explosive device and/or software code, a counter-intelligence device.

In further embodiments, the component (e.g., countermeasure component) 45 can also be a counter-intelligence device. In this embodiments, the counter-intelligence device would substitute false data for real data (e.g., it could change the contents of stored memory to that of false memory data). This can be done by way of software coding, as an example. In embodiments, the counter-intelligence device would send the reverse engineer incorrect data, which would not be distinguishable from correct data.

For example, in embodiments, the countermeasure component 45 can disable components by, e.g., mild explosion, application of high currents to the circuitry, disabling features through software algorithms, etc. By way of another illustrative and non-limiting example, the countermeasure component 45 can provide code which will disable a programmable gate array associated with component 15. By way of yet another illustrative and non-limiting example, the countermeasure component 45 can emit electromagnetic pulses (high current, high voltage spike) to render useless the electronic circuitry, e.g., component 15. In further embodiments, the countermeasure component 45 can include software code comprising encryption software to disable a software component or hardware component of the system.

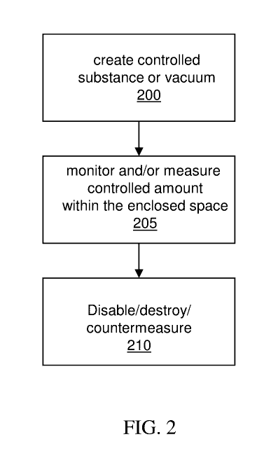

FIG. 2 is a flow chart showing steps in accordance with aspects of the invention. FIG. 2 may equally represent a high-level block diagram of the invention. The steps of FIG. 2 may take the form of an entirely hardware embodiment, an entirely software embodiment or an embodiment containing both hardware and software elements. Software embodiments include but are not limited to firmware, resident software, microcode, etc. Furthermore, the invention can take the form of a computer program product accessible from a computer-usable or computer-readable medium providing program code for use by or in connection with a computer or any instruction execution system. A computer-usable or computer readable medium can be any apparatus that can contain or store the program for use by or in connection with the instruction execution system, apparatus, or device. The medium can be an electronic, magnetic, optical, electromagnetic, infrared, or semiconductor system (or apparatus or device) and is non-transitory, per se.

At step 200, a controlled substance or a vacuum can be created within the enclosed space of the package, which may contain the intellectual property to be protected. At step 205, the controlled amount of the substance is monitored and/or measured within the enclosed space. Amounts of the substance can be measured to detect losses beyond a predetermined amount after the product is fielded, or as it sits in a factory or warehouse. For example, the predetermined amount can be: (i) when the air pressure falls to atmospheric pressure, (ii) there is no or minimal gas detected below the original amount, (iii) a vacuum is no longer in existence in the enclosure, or (iv) no more odor is detected in the enclosure. At step 210, upon detection of the loss of substance (or loss of a vacuum), e.g., changing beyond a predetermined amount, a countermeasure component provided with the enclosure, will disable or destroy at least one component.

In embodiments, the countermeasure component can be activated to disable or destroy any components, circuitry, software, etc., associated with the intellectual property. As an example, a recorded loss of the substance would trigger an erasure of memory and erasure or disabling of software loads and software encryption keys thus preventing a loss of a company's intellectual property investment. By way of example, the measurement and/or monitoring component can provide an activation signal to the countermeasure component, which would then disable or destroy any components, circuitry, software, etc., associated with the intellectual property as described herein. In this way, the systems and methods described herein can prevent a reverse engineer from obtaining the intellectual property thus avoid significant loss of investment. Moreover, it could take many copies of the product for the person (e.g., reverse engineer) to figure out that the intellectual property is being wiped clean or disabled due to a loss of “invisible” air pressure, CO2, etc., making the reverse engineer more apt to quit prior to stealing of the intellectual property. Also, software coding, as an example, can provide false data which would be indistinguishable from correct data.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, and combinations thereof such as are within the scope of the appended claims.

What is claimed is:

1. A system, comprising:
a measurement component provided with an enclosure, which measures environmental conditions within the enclosure; and
a countermeasure component provided with the enclosure, which renders inoperative at least one electronic or software component within the enclosure when the measurement component detects that the environmental conditions within the enclosure have changed beyond a predetermined amount.

2. The system of claim 1, wherein the environmental conditions measured include a controlled amount of substance within the enclosure.

3. The system of claim 1, wherein the measurement component detects one of air pressure, gas, an odor and vacuum leak within the enclosure.

4. The system of claim 3, wherein the measurement component comprises at least one of a pressure gauge, moisture detector and odor detector.

5. The system of claim 1, wherein the countermeasure component is at least one of an electrostatic discharge device (ESD), electromagnetic pulse device (EMP), a chemical device, a counter-intelligence device, an explosive device or software code to disable the electronic or software component.

6. The system of claim 1, wherein the enclosure is a hermetically sealed enclosure.

7. The system of claim 6, wherein the component, the at least one measurement component and the countermeasure component are a single component mounted on a board and provided within the hermetically sealed enclosure formed by a cover which is hermetically sealed to the board.

8. The system of claim 7, wherein the cover includes a temporary injection hole or valve which is plugged or sealed, respectively, after injection of the substance.

9. The system of claim 1, further comprising an additional component which provides the environmental conditions within the enclosure.

10. The system of claim 1, wherein the measurement component further comprises a monitoring function.

11. A system, comprising:
an enclosure comprising a board and a cover hermetically sealed to the board;
a first component provided with the enclosure and mounted to the board;
a second component provided with the enclosure and mounted to the board, the second component detects an environmental condition within the enclosure; and
a third component provided with the enclosure and mounted to the board, the third component disables or destroys the first component upon the second component detecting that the environmental condition within the enclosure has changed.

12. The system of claim 11, wherein the first component is at least one of a software component and a hardware component and the second component is a monitoring and measurement component which monitors the environmental condition within the enclosure and measures when the environmental condition changes a predetermined amount.

13. The system of claim 12, wherein the environmental condition is one of air pressure, a gas, an odor and a vacuum condition.

14. The system of claim 11, wherein the environmental condition is invisible.

15. The system of claim 11, wherein the third component is a countermeasure component which provides at least one of an explosion, application of high currents, disabling software code, electromagnetic pulse, or a counter-intelligence input to render useless the first component.

16. The system of claim 11, further comprising a fourth component which provides the environmental condition within the enclosure.

17. A method comprising:
monitoring an environmental condition within an enclosure;
detecting that the environmental condition has changed; and
disabling or altering an electronic or software component, upon the detecting of the change of the environmental condition.

18. The method of claim 17, wherein the environmental condition is one of air pressure, presence of a gas, an odor and a vacuum.

19. The method of claim 17, further comprising introducing the environmental condition with the enclosure.

20. The method of claim 19, wherein the introducing the environmental condition occurs after the enclosure is hermetically sealed.
